(19) United States
(12) Patent Application Publication
(10) Pub. No.: US 2012/0169523 A1
(43) Pub. Date: Jul. 5, 2012

(54) METHOD AND RADAR APPARATUS FOR DETECTING TARGET OBJECT

(75) Inventors: Jae Eun LEE, Hwaseong-si (KR); Seong Hee JEONG, Seoul (KR); Joo Yeol YANG, Namyangju-si (KR); Seung Un CHOI, Seoul (KR)

(73) Assignee: MANDO CORPORATION

(21) Appl. No.: 13/342,594

(22) Filed: Jan. 3, 2012

(30) Foreign Application Priority Data
Jan. 4, 2011 (KR) 10-2011-0000444

(51) Int. Cl. G01S 13/04

(52) U.S. Cl. 342/21

(57) ABSTRACT

Disclosed is a method and a radar apparatus for transmitting a transmission signal through a changing transmission frequency band in order to avoid signal interference, thereby exactly detecting a target object without misrecognition.

### CROSS-REFERENCE TO RELATED APPLICATION

This application claims priority from and the benefit under 35 U.S.C. §119(a) of Korean Patent Application No. 10-2011-0000444, filed on Jan. 4, 2011, which is hereby incorporated by reference for all purposes as if fully set forth herein.

### BACKGROUND OF THE INVENTION

1. Field of the Invention

The present invention relates to a radar technology, and more particularly to a method and a radar apparatus for transmitting a transmission signal through a changing transmission frequency band in order to avoid signal interference, thereby exactly detecting a target object without misrecognition.

2. Description of the Prior Art

Recently, many types of vehicle control systems for controlling a vehicle by using a radar apparatus for detecting a surrounding object have been developed. For exact control of a vehicle by such a vehicle control system, it is indispensable to achieve an exact detection of an object by a radar apparatus.

However, if a transmission signal transmitted for detection of an object by a radar apparatus makes an interference with a transmission signal transmitted by another surrounding radar apparatus or another communication apparatus, the radar apparatus may fail to detect a real object existing in the vicinity or misrecognize a virtual object, which is not a real object, as a real object.

### SUMMARY OF THE INVENTION

Accordingly, the present invention has been made to solve the above-mentioned problems occurring in the prior art, and an aspect of the present invention is to provide a method and a radar apparatus for reducing an interference between a transmission signal transmitted for detection of an object by the radar apparatus and a transmission signal transmitted by another radar apparatus or another communication apparatus located in the vicinity.

Another aspect of the present invention is to provide a method and a radar apparatus for reducing a probability that the radar apparatus may misrecognize a virtual object as a real object, so as to enable the radar apparatus to achieve an exact detection of a real object without misrecognition.

In order to accomplish this object, there is provided a radar apparatus mounted to a vehicle and detecting a target object around the vehicle, the radar apparatus comprising: a signal transmitter for transmitting a transmission signal at each transmission frequency cycle while changing a transmission frequency band according to the transmission frequency cycle within an available transmission frequency band; a signal receiver for receiving a reflection signal generated by reflection of a transmitted signal by surroundings; an interference signal remover for removing an interference signal from the received reflection signal by causing the reflection signal to pass through a filter; and a target object detector for detecting a target object based on the received reflection signal from which the interference signal has been removed.

In accordance with another aspect of the present invention, there is provided a method for detecting a target object around the vehicle by a radar apparatus mounted to a vehicle, the method comprising: transmitting a transmission signal at each transmission frequency cycle while changing a transmission frequency band according to the transmission frequency cycle within an available transmission frequency band; receiving a reflection signal generated by reflection of a transmitted signal by surroundings; removing an interference signal from the received reflection signal by causing the reflection signal to pass through a filter; and detecting a target object based on the received reflection signal from which the interference signal has been removed.

According to the present invention as described above, it is possible to reduce interference between a transmission signal transmitted for detection of an object by the radar apparatus and a transmission signal transmitted by another radar apparatus or another communication apparatus located in the vicinity.

Further, according to the present invention, it is possible to reduce a probability that the radar apparatus may misrecognize a virtual object as a real object, so as to enable the radar apparatus to achieve an exact detection of a real object without misrecognition.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a radar apparatus according to an embodiment of the present invention;

FIG. 2 is a view showing an example of detecting a target object by using a radar apparatus according to an embodiment of the present invention;

FIGS. 3A to 3C are graphs showing examples of a transmission signal, a received signal, and an interference signal in a radar apparatus according to an embodiment of the present invention;

FIGS. 4A to 4D are graphs showing examples of a transmission signal, a received signal, and an interference signal in a conventional radar apparatus;

FIG. 5 is a view showing an example of detecting a target object by using a conventional radar apparatus; and

FIG. 6 is a flowchart of a method for detecting a target object according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

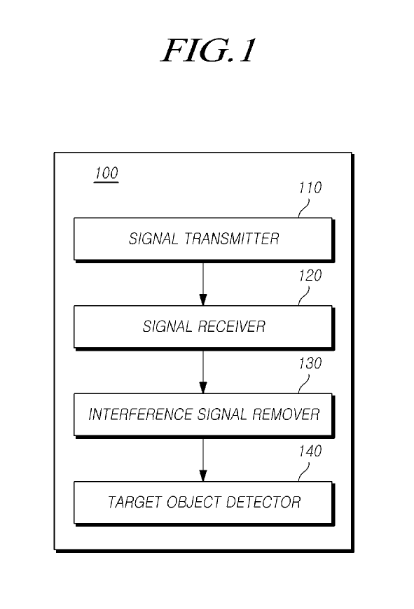

FIG. 1 is a block diagram of a radar apparatus 100 according to an embodiment of the present invention.

As shown in FIG. 1, the radar apparatus 100 according to an embodiment of the present invention includes a signal transmitter 110 for transmitting a transmission signal at each transmission frequency cycle while changing a transmission frequency band according to the transmission frequency cycle within an available transmission frequency band, a signal receiver 120 for receiving a reflection signal generated by reflection of a transmitted signal by surroundings, an interference signal remover 130 for removing an interference signal from a received signal by causing the received signal to pass through a filter, and a target object detector 140 for detecting a target object based on the received signal from which the interference signal has been removed.

The interference signal included in the signal received by the signal receiver 120 and removed by a filter may be, for example, a transmission signal transmitted from a radar apparatus mounted to another vehicle located in the vicinity of the current vehicle having the signal receiver 120.

The signal transmitter 110 described above changes the transmission frequency band according to the transmission frequency cycle within available frequency bands so that the transmission frequency band at one or more transmission frequency cycles becomes different from the frequency band of the interference signal.

That is, the signal transmitter 110 transmits the transmission signal while changing the transmission frequency band according to the transmission frequency cycle within the available frequency band, so as to prevent the frequency of the transmission signal from always coinciding with the frequency of the interference signal.

According to the transmission scheme of the transmission signal as described above, not only in the case in which the interference signal has a fixed frequency, but also in the case in which the frequency of the interference signal changes like the transmission signal, it is possible to reduce the probability that the frequency of the transmission signal and the frequency of the interference signal coincide with each other, so as to reduce the occurrence of false detection.

When the signal transmitter 110 as described above transmits a transmission signal at each transmission frequency cycle, the signal transmitter 110 may optionally determine the transmission frequency band according to the transmission frequency cycle within an available frequency band, may change the transmission frequency band of each transmission frequency cycle within the available frequency bands according to transmission frequency band sequence information, or may randomly change the transmission frequency band.

For example, when the signal transmitter 110 changes the transmission frequency band according to predetermined transmission frequency band change sequence information, and when the available frequency bands include a first transmission frequency band, a second transmission frequency band, a third transmission frequency band, a fourth transmission frequency band, and a fifth transmission frequency band, the signal transmitter 110 may sequentially change the transmission frequency band according to the “transmission frequency band change sequence information”, which indicates a change of frequency band in a sequence of the first transmission frequency band, the second transmission frequency band, the third transmission frequency band, the fourth transmission frequency band, and the fifth transmission frequency band. In the case of randomly changing the transmission frequency band, at each transmission frequency cycle, one of the first transmission frequency band, the second transmission frequency band, the third transmission frequency band, the fourth transmission frequency band, and the fifth transmission frequency band within the available frequency bands may be randomly extracted and the frequency band may be then changed to the extracted band.

The target object detector 140 as described above may perform, for example, a tracking of the signal received by the signal transmitter 110, from which the interference signal has been removed. By the tracking, the target object detector 140 counts the number of times by which an estimation object estimated as a target object is detected, and determines the estimation object as the real target object when the counted number of times is larger than or equal to a predetermined threshold. In contrast, when the counted number of times is smaller than the predetermined threshold, the target object detector 140 determines the estimation object as a ghost object due to the interference signal and makes a control to prevent the ghost object from being detected as the target object.

Through the tracking as described above, it is possible to determine an estimation object as a ghost object due to an interference signal and is thus possible to remove the interference signal which has not been removed yet by the interference signal remover 130.

As used herein, the “ghost object” refers to a virtual object, which is not a really existing object but is misrecognized like a real object due to an error or inaccuracy of the detection. Further, the ghost object may refer to a virtual object detected due to an interference signal.

If such a ghost object is detected by a radar apparatus 100, an inappropriate control may be performed in a vehicle control system using a result of the detection by the radar apparatus 100, and more seriously, a car accident or deadly consequences may occur.

Meanwhile, the radar apparatus 100 according to an embodiment of the present invention may be a radar apparatus employing one frequency modulation scheme among an FMCW (Frequency Modulated Continuous Wave) scheme, a Pulse Doppler scheme, an FSK (Frequency Shift Keying) scheme, and an FMSK (Frequency Modulated Shift Keying) scheme.

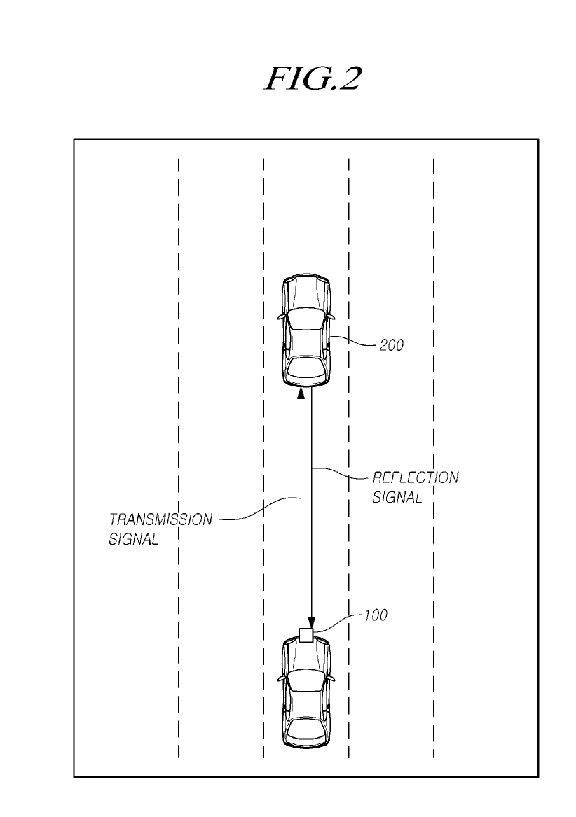

FIG. 2 is a view showing an example of detecting a target object 200 by using a radar apparatus 100 according to an embodiment of the present invention.

Referring to FIG. 2, the radar apparatus 100 mounted to a corresponding vehicle transmits a transmission signal through a transmission frequency band changing according to the transmission frequency cycle, removes an interference signal from a reflection signal from the surroundings and then performs a tracking of the reflection signal from which the interference signal has been removed, so as to obtain a pure reflection signal reflected from the real target object 200, and then detects the target object 200 based on the pure reflection signal.

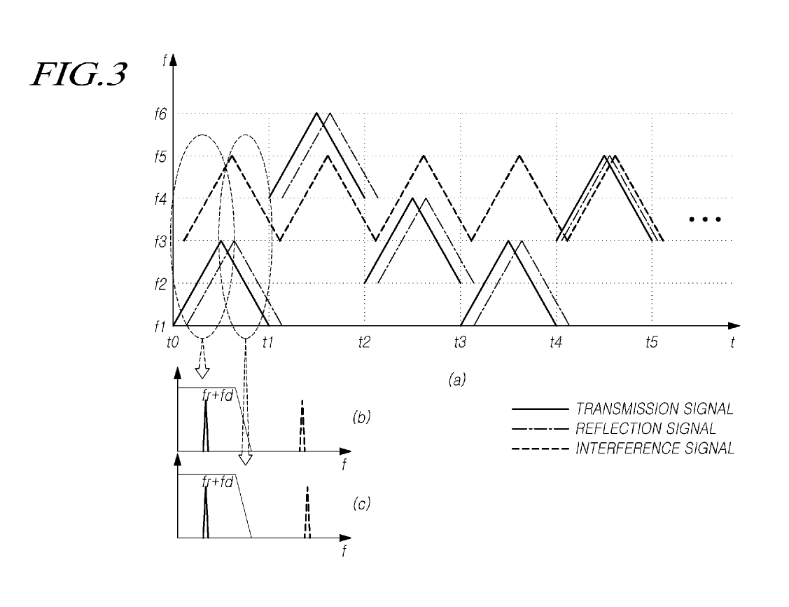

FIGS. 3A to 3C are graphs showing examples of a transmission signal, a received signal, and an interference signal in the radar apparatus 100 according to an embodiment of the present invention.

FIG. 3A is a graph of signals in which the x-axis corresponds to time, the y-axis corresponds to available frequency, available frequency bands include f1 to f6, and the transmission frequency cycle T has a value of (t1−t0) wherein t1−t0=t2−t1=t3−t2=t4−t3=etc. It is assumed that another nearby radar apparatus transmits a transmission signal through the same transmission frequency band f3˜f5 at every transmission frequency cycle T.

The radar apparatus 100 according to an embodiment of the present invention transmits a transmission signal through a transmission frequency band changing according to the transmission frequency cycle. For example, as shown in FIG. 3A, the radar apparatus 100 may transmit a transmission signal through a transmission frequency band (f1˜f3) in the first transmission frequency cycle (t0˜t1), transmit a transmission signal through a transmission frequency band (f4˜f6) in the second transmission frequency cycle (t1˜t2), transmit a transmission signal through a transmission frequency band (f2˜f4) in the third transmission frequency cycle (t2˜t3), transmit a transmission signal through a transmission frequency band (f1˜f3) in the fourth transmission frequency cycle (t3˜t4), and transmit a transmission signal through a transmission frequency band (f3˜f5) in the fifth transmission frequency cycle (t4˜t5). A received signal (i.e. a reflection signal received after being reflected by the target object 200), in which an interference signal has been removed from a signal received through reflection of the transmission signal by the surroundings, has a frequency band coinciding with the frequency band of a corresponding transmission signal.

Therefore, there is a high probability that the frequency band of the signal reflected by the target object 200 does not coincide with the transmission frequency band (f3˜f5) of a transmission signal transmitted from another radar apparatus located in the vicinity. As a result, it is possible to prevent the occurrence of signal interference between the signal (received signal) reflected by the target object 200 and the transmission signal transmitted from another radar apparatus.

A more detailed description will be given below. On an assumption that, together with a received signal (indicated by the one-dot-chain line in FIG. 2A) obtained through reflection of a transmission signal (indicated by the solid line in FIG. 2A) by the target object 200, an interference signal indicated by the broken line is received, a signal by which it is possible to calculate the speed of an object and distance information is obtained by a frequency difference between the transmission signal and the received signal. In general, frequency difference between the transmission signal and the interference signal is larger than the frequency difference between the transmission signal and the received signal.

In this case, it is possible to remove most of the interference signal by a filter, such as a Low Pass Filter (LPF). This phenomenon can be expressed as shown in FIGS. 3B and 3C in the frequency domain. As shown in FIGS. 3B and 3C, by changing the transmission frequency band of the transmission signal at each transmission frequency cycle, it is possible to yield a large frequency difference between the interference signal and the transmission signal, so that it is possible to easily remove the interference signal by an LPF.

Signals of the up-chirp interval and down-chirp interval in FIG. 3A can be expressed as FIGS. 3B and 3C by frequency extraction through a Fast Fourier Transform (FFT), respectively. By using the extracted frequencies, it is possible to detect the target object 200 and thus obtain the distance and the speed of the target object 200.

In FIGS. 3B and 3C, fr indicates a frequency variance according to the distance and fd indicates a Doppler frequency according to the speed, and they can be defined by Equations (1) and (2), respectively.

$$\begin{matrix}{f}_{r} = \frac{2 R}{C} \times \frac{B}{τ} & ( 1 ) \\ {f}_{d} = \frac{2 V}{C} \times {f}_{c} & ( 2 )\end{matrix}$$

In equations (1) and (2), R indicates the distance, V indicates the speed, C indicates the speed of light, B indicates a bandwidth (transmission frequency band), T indicates a chirp time, and fc indicates a central frequency.

By combining equations (1) and (2), it is possible to obtain the distance R and the speed V of the target object 200.

As described above, by changing the transmission frequency band of a transmission signal at each transmission frequency cycle, it is possible to enlarge the frequency difference between an interference signal and a transmission signal and it is thus possible to easily remove the interference signal by an LPF, so as to avoid signal interference. This remarkably lowers the probability that the detected object may be a ghost object other than a real object, so as to increase a probability of exact detection of the target object 200, which is a real object. Further, a vehicle control system using the radar apparatus 100 can perform a more exact vehicle control.

Even when another radar apparatus mounted to a surrounding vehicle, etc. is a radar apparatus 100 according to an embodiment of the present invention, that is, even when another radar apparatus transmits a transmission signal through a changing transmission frequency band, if the timing coincides, that is, if the transmission frequency bands of transmission signals transmitted from two radar apparatuses 100 coincide with each other, a false object may be erroneously detected as a target object 200. However, during the tracking operation, in order to prevent an object, which has been detected once and is estimated as the target object 200, from being finally determined as the final target object 200, a track for the final target object 200 is not instantly generated. However, only after the estimated object is detected several times, a track for the final target object 200 is generated and the estimated object is finally determined as the final target object 200. Therefore, in view of the probability, the number of times the target may be erroneously detected is reduced.

That is, the radar apparatus 100 according to an embodiment of the present invention can filter off an erroneously detected estimation object due to an interference signal with the target object 200, which is a real object, through a tracking process. Therefore, it is possible to remarkably reduce the probability of erroneous target detection and thus the error in controlling a vehicle.

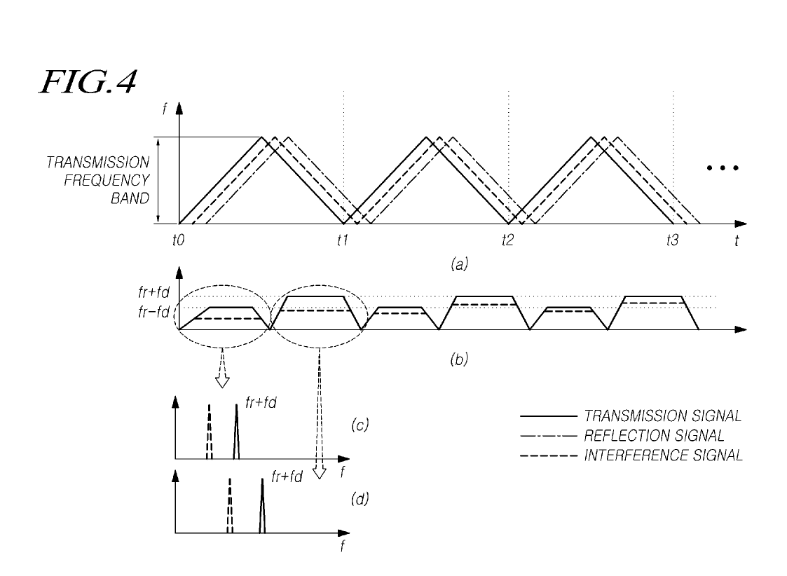

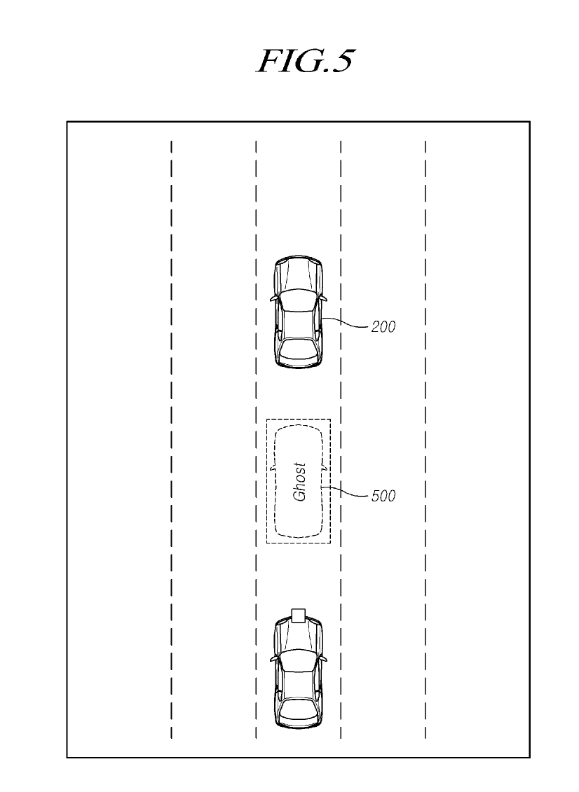

Hereinafter, in order to show the effect of the radar apparatus 100 according to an embodiment of the present invention more clearly, a conventional radar apparatus 100 will be described with reference to FIGS. 4 and 5.

FIGS. 4A to 4D are graphs showing examples of a transmission signal, a received signal, and an interference signal in a conventional radar apparatus.

For example, the conventional radar apparatus may use a Frequency Modulated Continuous Wave (FMCW) scheme. Then, as shown in FIG. 4A, the conventional radar apparatus transmits a transmission signal after modulating the frequency within the same particular bandwidth (i.e. available bandwidth) using the same particular carrier frequency and then receives a signal having a changed frequency generated through reflection of the transmission signal by a target object 200, so as to obtain the speed and distance of the target object 200, thereby detecting the target object 200.

However, when there are many simultaneously operating radar apparatuses, interference may occur between radar apparatuses using the same frequency band (available frequency band). In this case, as shown in FIG. 5, due to a received signal generated by the interference, a ghost object 500 instead of a real object may be detected or the entire Signal to Noise Ratio (SNR) of the received signal may be degraded so as to degrade the performance of detecting an object.

FIG. 4B is a graph showing the frequency difference (solid line) between the transmission signal and the received signal and the frequency difference (broken line) between the transmission signal and the interference signal.

By using the graph shown in FIG. 4B, the frequency component in the up-chirp interval and the frequency component in the down-chirp interval can be expressed as FIGS. 4C and 4D, respectively. In FIGS. 4C and 4D, the frequency component extracted by the real target object 200 is indicated by a solid line and the frequency component due to the interference signal is indicated by a broken line. In FIGS. 4C and 4D, fr indicates a frequency variance according to the distance and fd indicates a Doppler frequency variance according to the speed.

In this example, as a result of the detecting using the frequency component extracted from the received signal corresponding to a reflection signal generated by reflection of the transmission signal by the real target object 200, the vehicle 200 is detected as shown in FIG. 5. In contrast, as shown in FIGS. 2B to 2D, since the frequency of the interference signal is lower than that of the received signal generated by the real target object 200, a ghost object 500 at a nearer location may be detected as shown in FIG. 5, so as to cause an unnecessary quick braking due to the detection of the ghost object 500. This may increase the dangerous possibility of collision in an actual road situation.

In order to overcome such problems, a radar apparatus 100 according to an embodiment of the present invention transmits a transmission signal while changing the transmission frequency band, through which the transmission signal is transmitted, according to each transmission frequency cycle.

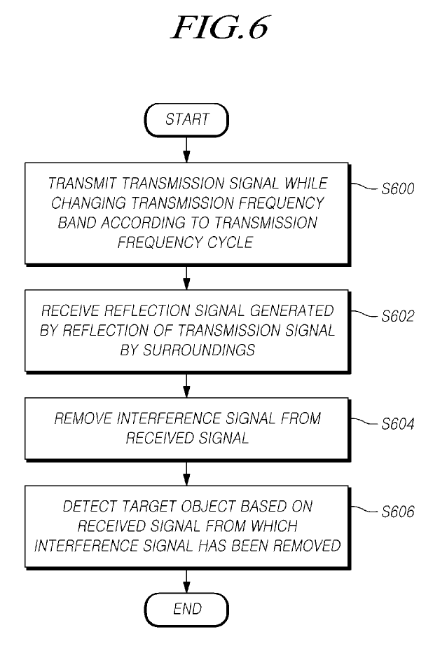

FIG. 6 is a flowchart of a method for detecting a target object by a radar apparatus 100 according to an embodiment of the present invention.

Referring to FIG. 6, the method for detecting a target object according to an embodiment of the present invention includes: transmitting a transmission signal at each transmission frequency cycle while changing a transmission frequency band according to the transmission frequency cycle within an available transmission frequency band (step S600); receiving a reflection signal generated by reflection of the transmission signal by the surroundings (step S602); removing an interference signal from the received reflection signal by causing the reflection signal to pass through a filter (step S604); and detecting a target object based on the received reflection signal from which the interference signal has been removed (step S606).

As described above, the present invention can reduce the interference between a transmission signal transmitted for detection of an object by a radar apparatus 100 and a transmission signal transmitted by another radar apparatus or another communication apparatus located in the vicinity.

Further, the present invention can reduce a probability that the radar apparatus may misrecognize a virtual object as a real object, so as to enable the radar apparatus to achieve an exact detection of a real object without misrecognition.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A radar apparatus mounted to a vehicle and detecting a target object around the vehicle, the radar apparatus comprising:
a signal transmitter for transmitting a transmission signal at each transmission frequency cycle while changing a transmission frequency band according to the transmission frequency cycle within an available transmission frequency band;
a signal receiver for receiving a reflection signal generated by reflection of a transmitted signal by surroundings;
an interference signal remover for removing an interference signal from the received reflection signal by causing the reflection signal to pass through a filter; and
a target object detector for detecting a target object based on the received reflection signal from which the interference signal has been removed.

2. The radar apparatus as claimed in claim 1, wherein the interference signal is a transmission signal transmitted from a radar apparatus mounted to another vehicle located around the vehicle.

3. The radar apparatus as claimed in claim 1, wherein the signal transmitter changes the transmission frequency band according to the transmission frequency cycle within the available transmission frequency band so that a transmission frequency band at one or more transmission frequency cycles becomes different from a frequency band of the interference signal.

4. The radar apparatus as claimed in claim 1, wherein, when the signal transmitter transmits the transmission signal, the signal transmitter optionally determines the transmission frequency band according to the transmission frequency cycle within the available frequency band, changes the transmission frequency band of each transmission frequency cycle within the available frequency band according to predetermined transmission frequency band sequence information, or randomly changes the transmission frequency band.

5. The radar apparatus as claimed in claim 1, wherein the signal transmitter transmits the transmission signal while changing the transmission frequency band according to the transmission frequency cycle within the available frequency band, so as to prevent the frequency of the transmission signal from always coinciding with the frequency of the interference signal.

6. The radar apparatus as claimed in claim 1, wherein the target object detector performs a tracking of the signal, so as to count the number of times by which an estimation object estimated as a target object is detected, and determine the estimation object as the real target object when the counted number of times is larger than or equal to a predetermined threshold.

7. The radar apparatus as claimed in claim 1, wherein the target object detector performs a tracking of the signal so as to count the number of times by which an estimation object estimated as a target object is detected, and when the counted number of times is smaller than a predetermined threshold, the target object detector determines the estimation object as a ghost object due to the interference signal and makes a control to prevent the ghost object from being detected as the target object.

8. A method for detecting a target object around the vehicle by a radar apparatus mounted to a vehicle, the method comprising:
transmitting a transmission signal at each transmission frequency cycle while changing a transmission frequency band according to the transmission frequency cycle within an available transmission frequency band;
receiving a reflection signal generated by reflection of a transmitted signal by surroundings;
removing an interference signal from the received reflection signal by causing the reflection signal to pass through a filter; and
detecting a target object based on the received reflection signal from which the interference signal has been removed.
